(19) United States
(12) Patent Application Publication
(10) Pub. No.: US 2023/0004711 A1
(43) Pub. Date: Jan. 5, 2023

(54) DYNAMIC ITERATION OF GROUPED COMPONENTS IN A TEMPLATE

(71) Applicant: Klaviyo Inc., Boston, MA (US)

(72) Inventors: Shresth Bhatnagar, Boston, MA (US); Daniel Kezerashvili, Boston, MA (US); Nikita Shenkman, Boston, MA (US)

(73) Assignee: Klaviyo Inc., Boston, MA (US)

(21) Appl. No.: 17/839,380

(22) Filed: Jun. 13, 2022

Related U.S. Application Data
(60) Provisional application No. 63/217,337, filed on Jul. 1, 2021.

(51) Int. Cl. G06F 40/186; G06F 16/28; G06F 40/174

(52) U.S. Cl. CPC G06F 40/186; G06F 16/287; G06F 40/174

(57) ABSTRACT

Methods and systems for improved template compilation are disclosed. The system can enable repeating the content of grouped components for each entry in a designated data array from a custom database. With the same design style, each of the iterated components can contain individually different content based on the custom variables in the array. The system can improve efficiency in creating the customized email template. Furthermore, by relying on the custom databases, the system can optimize the template customization process to create personalized templates that match the customer's interests as wells as the business's goals.

### CROSS-REFERENCES TO RELATED APPLICATIONS

This application claims the benefit of U.S. Provisional Patent Application No. 63/217,337, entitled “Email Customization,” filed Jul. 1, 2021, which is incorporated herein by reference for all purposes.

### TECHNICAL FIELD

The present subject matter relates to systems and methods for data integration, compilation, and update of an electronic mail template. More specifically, the present subject matter relates to efficiently repeat grouped components in an email template.

### BACKGROUND

Digital marketing has become a powerful way to promote a business's products and services to its customers. Among digital marketing's various tools, computer-compiled marketing emails can directly deliver the most relevant content to a customer. Such emails can be customized based on the customer's preference and other information. Sometimes, it is necessary to selectively repeat a portion of the content in an email, which can be time consuming to create.

As such, there are a lot of areas for improving the email customization process and optimizing the computer system performance.

### SUMMARY OF THE INVENTION

The present subject matter describes improved methods for email template compilation via a computer network. The system can enable repeating the content of grouped components, such as a section or a block, for each entry in a designated data array from an event or profile database, or from a data feed. Each of the iterated components can share the same design style but contain individually different content based on the custom variables in the array. Furthermore, the number of the iterated components dynamically corresponds to the number of entries in the designated array as the components are repeated once per item in the array.

Compared with prior approaches, the present subject matter can improve computer and network efficiency by eliminating duplicating and modifying each grouped componentS individually. As the system can dynamically populate iterated sections based on the designated data, it can also improve efficiency in creating the customized email template.

In addition, by relying on multiple custom databases, the system can streamline and optimize the email customization process to create personalized emails, which can match the customer or recipient's interests and the business's goals.

A computer implementation of the present subject matter comprises a method of iterating a section, the method comprises: receiving, at an email customization server, a template comprising a section, a block or grouped components, wherein the section comprises one or more components in a relational database, assigning a plurality of dynamic data entries to be associated with a dynamic component of the one or more components, retrieving the plurality of dynamic data entries from one or more databases for populating the dynamic component, and generating iterated sections based on the plurality of dynamic data entries within the template, wherein each dynamic data entry corresponds to a respective iterated section, and wherein each dynamic data entry is configured to populate one dynamic component in one respective iterated section. The method can further comprise receiving a request to repeat the section within the template based on the plurality of dynamic data entries. According to some embodiments, the plurality of dynamic data entries is an array, i.e., list, of data that stores multiple pieces of data that are structured in the same way. Furthermore, the number of iterated sections corresponds to the quantity of the dynamic data entries in the array.

According to some embodiments, the custom databases comprise a recipient's event database, a customer profile database, a business's product database, or other data feed. According to some embodiments, the one or more components of the sections are multi-level hierarchical components, e.g., rows, columns, and blocks.

Another computer implementation of the present subject matter comprises a method of iterating a section, the method comprises: receiving, at a client device, a template comprising a section, a block or grouped components, wherein the section comprises one or more components in a relational database, assigning a plurality of dynamic data entries to be associated with a dynamic component of the one or more components, retrieving the plurality of dynamic data entries from one or more databases for populating the dynamic component, and generating iterated sections based on the plurality of dynamic data entries within the template, wherein each dynamic data entry corresponds to a respective iterated section, and wherein each dynamic data entry is configured to populate one dynamic component in one respective iterated section. The method can further comprise receiving a request to repeat the section within the template based on the plurality of dynamic data entries. Furthermore, the number of iterated sections corresponds to the quantity of the dynamic data entries in the array.

Other aspects and advantages of the present subject matter will become apparent from the following detailed description taken in conjunction with the accompanying drawings, which illustrate, by way of example, the principles of the present subject matter.

### DESCRIPTION OF DRAWINGS

The present subject matter is illustrated by way of example, and not by way of limitation, in the figures of the accompanying drawings in which:

FIG. 1 shows an exemplary diagram of an email customization system for dynamic section iteration, according to one or more embodiments of the present subject matter;

FIG. 2 shows an exemplary process for dynamic section iteration within a template, according to one or more embodiments of the present subject matter;

FIG. 3 shows an exemplary layout of a template with iterated sections or grouped components, according to one or more embodiments of the present subject matter;

FIG. 4 shows exemplary hierarchical components of a template, according to one or more embodiments of the present subject matter;

FIG. 5A shows an exemplary representation of a template, according to one or more embodiments of the present subject matter;

FIG. 5B shows an exemplary template stored in a relational database, according to one or more embodiments of the present subject matter;

FIG. 6 shows an exemplary process for dynamic section iteration within a template, according to one or more embodiments of the present subject matter;

FIG. 7 shows a flow chart that includes steps of a method of email customization, according to one or more embodiments of the present subject matter;

FIG. 8 shows a flow chart that includes steps of a method of email customization, according to one or more embodiments of the present subject matter;

FIG. 9 shows a system that operates to perform template serialization for pre-rendering and versioning, according to one or more embodiments of the present subject matter;

FIG. 10A shows a server system of rack-mounted blades, according to one or more embodiments of the present subject matter;

FIG. 10B shows a diagram of a networked data center server, according to one or more embodiments of the present subject matter;

FIG. 11A shows a packaged system-on-chip device, according to one or more embodiments of the present subject matter; and

FIG. 11B shows a block diagram of a system-on-chip, according to one or more embodiments of the present subject matter.

### DETAILED DESCRIPTION

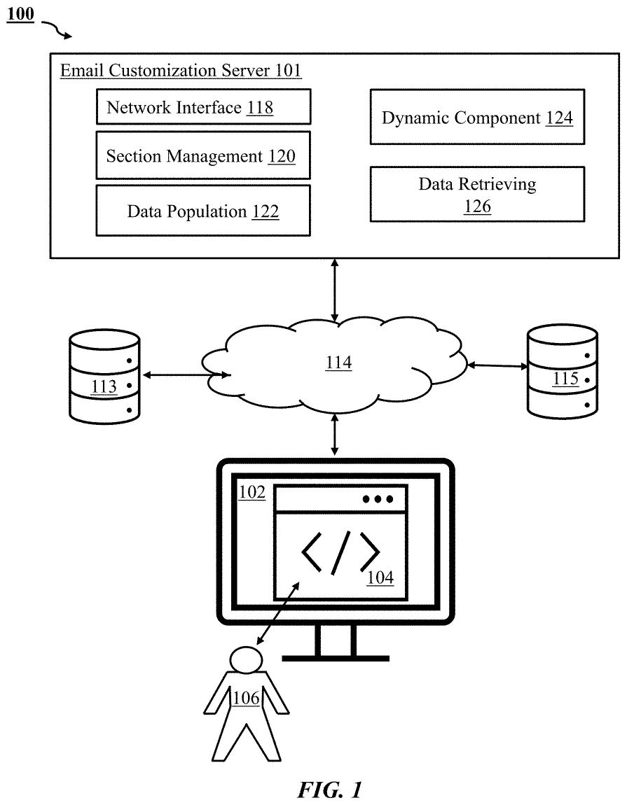

The present subject matter pertains to improved approaches for dynamically repeating a portion of a template. Embodiments of the present subject matter are discussed below with reference to FIGS. 1-10.

In the following description, for purposes of explanation, numerous specific details are set forth in order to provide a thorough understanding of the present subject matter. It will be apparent, however, to one skilled in the art that the present subject matter may be practiced without some of these specific details. In addition, the following description provides examples, and the accompanying drawings show various examples for the purposes of illustration. Moreover, these examples should not be construed in a limiting sense as they are merely intended to provide examples of embodiments of the subject matter rather than to provide an exhaustive list of all possible implementations. In other instances, well-known structures and devices are shown in block diagram form in order to avoid obscuring the details of the disclosed features of various described embodiments.

The following sections describe systems of process steps and systems of machine components for efficiently creating a customized template. These can be implemented with computers that execute software instructions stored on non-transitory computer-readable media. An improved template management system can have one or more of the features described below.

FIG. 1 shows an exemplary diagram of an email customization system 100 for dynamic section iteration within a template, according to one or more embodiments of the present subject matter. A template can comprise a set of components or data objects that combine to represent a structure of an email, which is rendered as a computer-compiled HTML web page. The template can be stored a relational database via normalized and related data components or tables, such as body, sections, rows, columns, blocks and sub-blocks.

According to some embodiments, a template can comprise a body with sections. Sections can be grouped components or content blocks, and can be used to organize the template. According to some embodiments, the grouped components of the sections are multi-level hierarchical components, e.g., rows, columns, and blocks. According to some embodiments, a template comprises at least one section. A block or component is a pre-defined structure that can be represented in both a database and in the email editor. A block can comprise a sub-block. For example, a table block can be a sub-block of a section block, and a table image or table text block can be sub-blocks of a table block. For example, a section can be responsible for the layout and general configuration and the blocks can display the specific products.

According to some embodiments, a section can have a section style, such as background color and image, that span through multiple content blocks. Sometimes, it is needed to generate iterated sections with the same section style. However, the content of the iterated sections varies according to the designated dynamic variables, for example, a list of products a customer has purchased.

For example, the template can be an email template with structures and components that can be modified by a computing device or a client device. The template can comprise nested relational database tables comprising components/blocks, settings, content, and position information for the template. According to some embodiments, the email template can be marketing emails that can directly deliver relevant content to a customer. These marketing emails can be generated by modifying a template email according to various factors such as the specific offering or the customer's previous behavior data.

As shown in FIG. 1, a user 106 of the email customization system 100 can compile a template 104 via a client device 102, which can communicate with a relational database 113, a custom database 115, and an email customization server 101 via a network 114. Client device 102 can be a computing device that has at least one input interface for receiving template modification requests and at least one network interface for network connection.

Network 114 can comprise a single network or a combination of multiple networks, such as the Internet or intranets, wireless cellular networks, local area network (LAN), wide area network (WAN), WiFi, Bluetooth, near-field communication (NFC), etc. Network 114 can comprise a mixture of private and public networks or one or more local area networks (LANs) and wide-area networks (WANs) that may be implemented by various technologies and standards.

Email customization server 101 can comprise a number of modules or units to implement functions of the present subject matter. According to some embodiments, Email customization server 101 can implement functions related to network interface 118, section management 120, data population 122, dynamic component 124, and data retrieving 126.

The email customization server 101 can enable repeating the content of a section or a block, for each entry in a dynamic data entries, i.e., array, from a custom database. The system user 106 can compile an Email template that is stored and retrieved from relational database 113. The template can comprise a section that needs to repeat its style. To achieve that, section management 120 can assign an array or a list of data to a dynamic component of the section. An array can store multiple pieces of data that are structured the same way in a custom database. The custom databases can comprise a recipient's event database, a customer profile database, a business's product database, or a business's web data feed.

According to some embodiments, a customer event includes an action the recipient has taken to engage with a business. For at least some embodiments, actions the recipient has taken include one or more of product viewed by the recipient, products purchased by the recipient, onsite action of the recipient, and emails received by the recipient. Such event data can include date/time email was sent and received, the specific email that was received, whether the recipient engaged with the email, etc.

For example, a customer's purchased products can be stored as an array within a Placed Order event in an event database. The items array can contain one entry per item ordered, and each entry contains the details for one item, e.g., item name, image URL, quantity, size, color, etc. The iterated sections, as generated, can share the same design style but each contains different product details, such as item name and image URL. For example, these iterated sections can be included in an order confirmation email to display a customer's purchased item, including a product's image, price, title and variant information.

Other exemplary dynamic iteration of a section can show a customer a list of their active subscriptions in a campaign, which can be generated based on the array of existing subscriptions. Also, it can provide an up-to-date list of a business's most recent blog posts based on the array of recent blog entries from a custom web feed. The dynamic section iteration can be based on any data array stored in a custom database such as a customer's profile database, an event database, or one of the business's web feeds.

To assign a specific data array, the system can prompt the system user 106 to identify the designated data array as dynamic component 124. For example, once the system user 106 selected a section for repeat, the system can prompt the user to identify the data array for iteration via a “Repeat For” filed. In this example of listing a customer's purchased item, the appropriate setting for the Repeat For field can be “event.extra.line_items”.

In addition, the system user 106 can further add dynamic variables to the content block for iteration. For example, “item.variant_price” and “item.title” can be added to enable repeating the block once per item in the array, wherein each repetition can show the title and price of each purchased product.

Upon receiving a request to repeat the sections, the system can retrieve the data entries via data retrieving 126 according to the identified data path and generate corresponding iterated sections via data population 122. As such, everything in the block or section with the iterated sections shall be repeated once per item in the designated array.

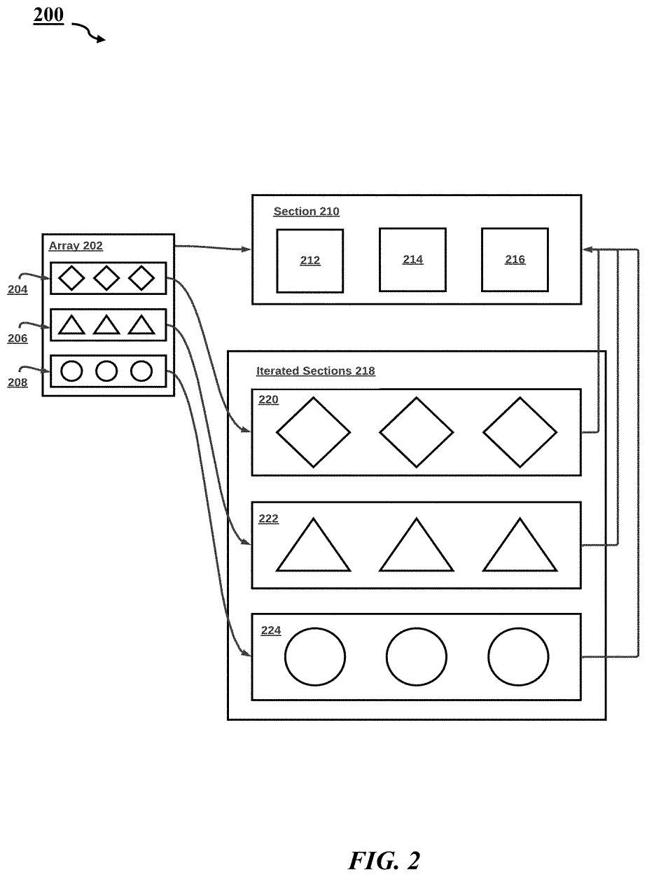

FIG. 2 shows an exemplary process 200 for dynamic section iteration within a template, according to one or more embodiments of the present subject matter. The section 210 for iteration can be generated based on data array 202. For example, data array 202 can contain one entry per item ordered, such as first product 204, second product 206, and third product 208. Each entry contains the details for one product, e.g., item name, image URL, quantity, size, color, as represented by the square, triangle, and circle data pieces. Based on the data array 202, section 210 can comprise first data placeholder 212, second data placeholder 214, and third data placeholder 216 corresponding to each data piece within an entry.

As shown in FIG. 2, the iterated sections 218 can be generated based on the content and number of the entries in data array 202. For example, the design style of the repeated sections 220, 222 and 224 can remain the same. The content of each repeated sections 220, 222 and 224 can be different and correspond to the details of first product 204, second product 206 and third product 206. Furthermore, the system can generate three iterated sections because there are three entries in data array 202.

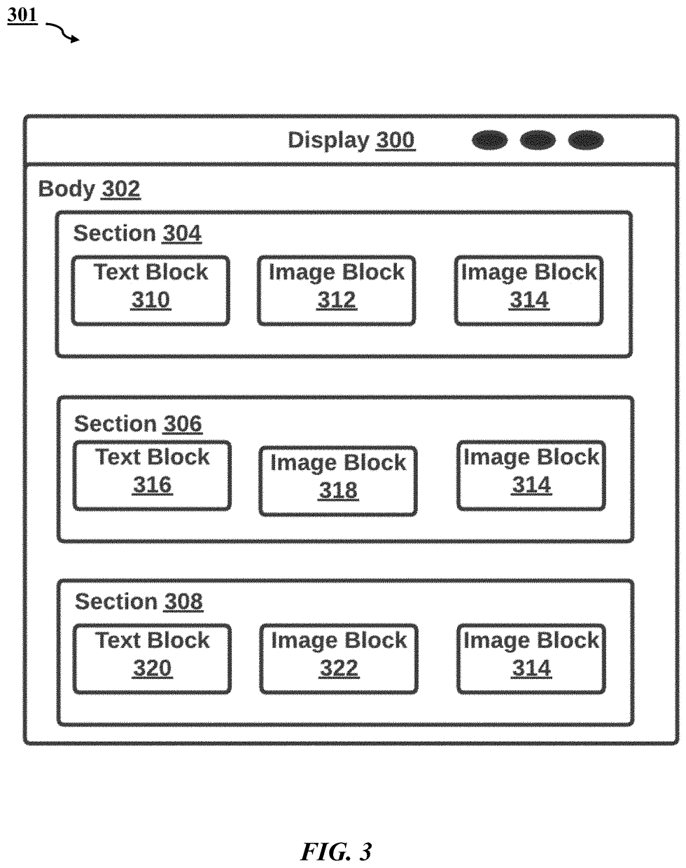

FIG. 3 shows an exemplary layout of a customized template 301 with iterated sections or grouped components, according to one or more embodiments of the present subject matter. The Email customization system can use the section iteration feature to generate customized template 301. As shown in FIG. 3, body 302 can comprise iterated sections 304, 306 and 308, each of which is generated based on one data entry in a designated array stored in a custom database, e.g., a Placed Order event in an event database. For example, iterated section 304 can comprise text block 310 to describe a first product name, and image block 312 to show a first product's image; iterated section 306 can comprise text block 315 to describe a second product name, and image block 318 to show a second product's image; iterated section 308 can comprise text block 320 to describe a third product name, and image block 322 to show a third product's image. In addition to these dynamic components, each of the iterated sections 304, 306 and 308 can also include an identical image block 314, which corresponds to a static component. In addition, the overall style of the iterated sections 304, 306 and 308 can remain the same.

As such, the system can improve computer and network efficiency by eliminating duplicating and modifying each section individually. By dynamically populating iterated sections based on the designated data, the system can improve the efficiency in creating customized template 301. Furthermore, the system can optimize the email customization process to create personalized emails that match the customer's interests as well as the business's goals

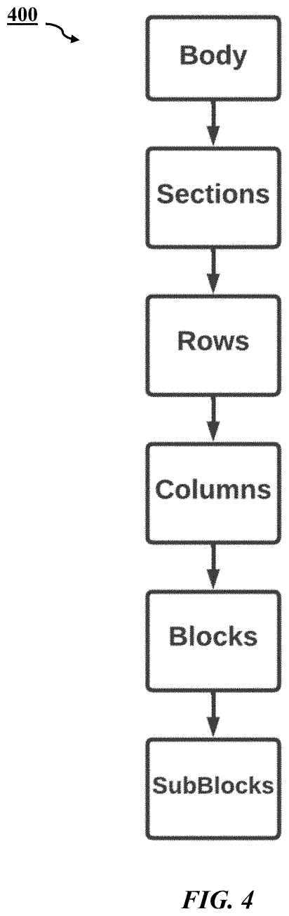

FIG. 4 shows exemplary hierarchical components of a template 400. A template can be stored in a relational database via normalized and related data components, such as body, sections, rows, columns, blocks and sub-blocks. The template data can be normalized and nested tables comprising components/blocks, settings/content, and position information for the template.

When being rendered as an email, relevant data of the template can be converted into a computer-compiled HTML web page showing the embedded components, such as sections and blocks. According to some embodiments, a component is a pre-defined structure that can be represented in both the relational database and in the email editor, and which can be rendered into HTML and configured by its display settings and sub-components as well as its content. According to some embodiments, the template data can be rendered as an email template in the JSON data structure that can be configured or modified by a computing device or a client device.

As illustrated in FIG. 4, the template 400 can comprise hierarchical components or blocks in a relational database. For example, a first-level component can be a body, which can comprise sections as second-level components. Sections can further comprise rows as third-level components. Furthermore, rows can comprise columns as a fourth-level component. Columns can comprise blocks as fifth-level components, which can further comprise subblocks as sixth-level components. At each level, one or more components can depend on the previous-level component(s).

According to some embodiments, the relational database can be a MySQL database or any relational database. Each component of the template can correspond to one or more related tables, which define the structure and content of the component, as well as its relationship with other components.

According to some embodiments, the iterated grouped components can be sections or blocks. According to some embodiments, the iterated grouped components can also be bodies, rows and columns.

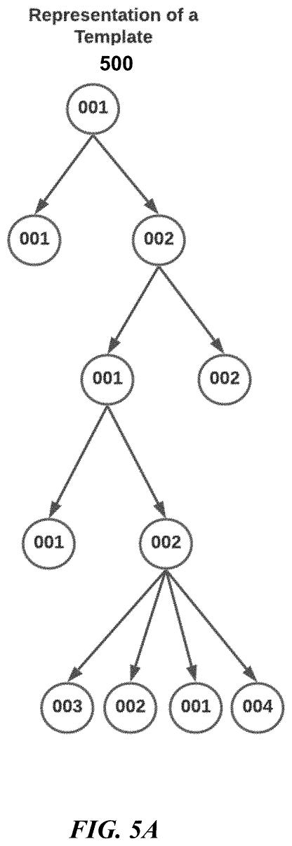

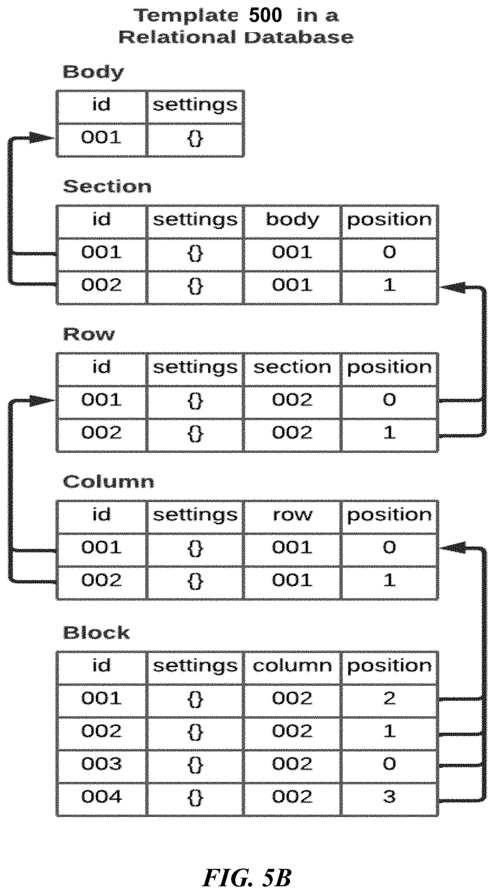

FIG. 5A shows an exemplary anatomy of a template 500 and FIG. 5B shows the template stored in a relational database. As shown in FIG. 5A, template 500 can comprise a number of components or blocks, including a body 001 that further comprises a section 001 and a section 002. Section 002 can comprise a row 001 and a row 002. Row 001 can further comprise a column 001 and a column 002, which comprise four blocks 003, 002, 001 and 004, respectively.

FIG. 5B is the relational database of the template 500 as shown in FIG. 5A. As shown in this figure, the relational database of the template 500 can comprise a number of related normalized data tables, including body table, section table, row table, column table and block table. For example, body table has an ID 001 and its corresponding settings, which can define the color, size, font, and content of the body. Body table can be related to section table that can comprise section 001 and section 002. Each of these sections can have its respective settings and position within body 001, i.e., position 0 and position 1. Similarly, section 002 can comprise row 001 and row 002, each of which has its respective settings and positions within section 002. Row 001 can comprise columns 001 and 002 with its respective settings and positions within the row. In addition, column 002 can comprise four individual blocks 001, 002, 003 and 004, which are located in its corresponding position 2, 1, 0 and 3.

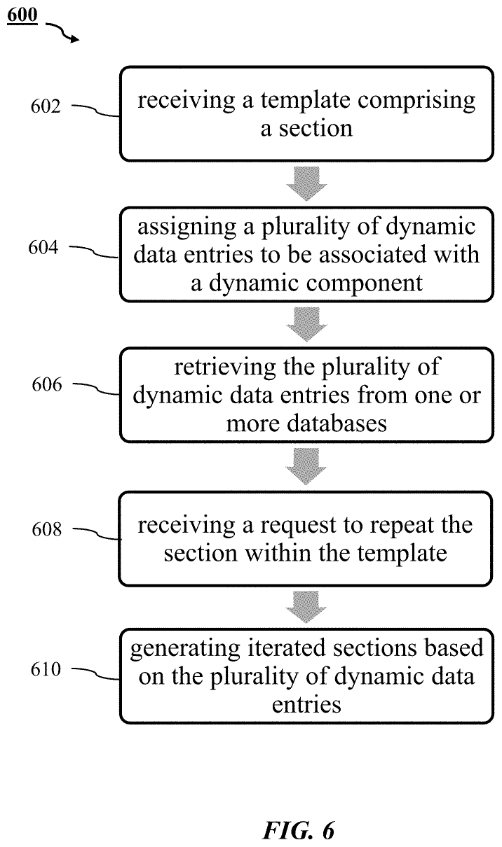

FIG. 6 shows an exemplary process 600 for dynamic section iteration within a template, according to one or more embodiments of the present subject matter. At step 602, the system can receive a template comprising a section, wherein the section comprises one or more components in a relational database. At step 604, the system can assign a plurality of dynamic data entries to be associated with a dynamic component of the one or more components. At step 606, the system can retrieve the plurality of dynamic data entries from one or more custom databases for populating the dynamic component. At step 608, the system can receive a request to repeat the section within the template. At step 610, the system can generate iterated sections based on the plurality of dynamic data entries within the template, wherein each dynamic data entry corresponds to a respective iterated section.

The following described embodiments include systems, methods, and apparatuses for email customization. Generally, email recipients receive many emails a day. Therefore, businesses that send email need to capture the attention of the email recipients. A recipient is more likely to engage with the content of received emails if the content is relevant to the recipient. Relevant content can be generated by understanding and tracking how the email recipient engages with branding of the businesses, including determining interests of the email recipient, and determining what specific content the email recipient has engaged with in the past, such as, through a marketing message or through interaction with a website of the business.

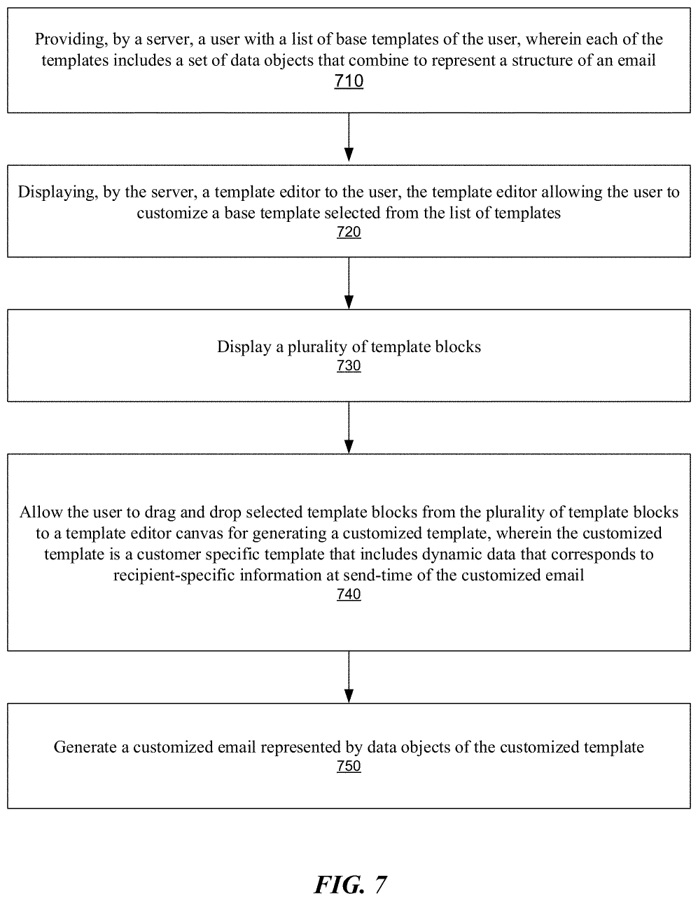

FIG. 7 is a flow chart that includes steps of a method of email customization, according to an embodiment. A first step 710 includes providing, by a server, a user with a list of base templates of the user, wherein each of the templates includes a set of data objects that combine to represent a structure of an email. A second step 720 includes displaying, by the server, a template editor to the user, the template editor allowing the user to customize a base template selected from the list of templates. For an embodiment, the template editor is configured to perform a third step 730 including displaying a plurality of template blocks, a fourth step 740 including allowing the user to drag and drop selected template blocks from the plurality of template blocks to a template editor canvas for generating a customized template, wherein the customized template is a customer specific template that includes dynamic data that corresponds to recipient-specific information at send-time of the customized email, and a fifth step 750 that includes generating a customized email represented by data objects of the customized template.

For an embodiment, the user modifies the base template by adding or removing blocks in order to create the layout and content of the email message the user wants to send to their recipients (wherein the recipient may be customers of the user). For an embodiment, the layout and content of the email of the customized template may be tailored to the individual recipient using dynamic data. The email sent and received by the customer is rendered according to the blocks and content as designed in the editor by the user.

For an embodiment, the recipient-specific information includes profile properties of the recipient including at least one of name, address. organization name, organization address, age, and/or language.

Dynamic Data

As previously stated, for an embodiment, the customized template is a customer specific template that includes dynamic data that corresponds to recipient-specific information at send-time of the customized email. For an embodiment, using a templating language, e.g., Django, or other methods, the user can specify tags, variables, or other programmatic tools or user interfaces which point to profile properties or event data (actions the recipient took in relation to a previous email message or actions the recipient took on the user's website which has been linked to the email customization system, e.g., Klaviyo, via a Javascript snippet that is embedded on their website) attached to recipient's record within the email customization system. This allows the user to inject this data into their customized template such that when the recipient (customer) receives the email, the message will include data that is individualized and customized to the recipient's experience with the user's brand or company.

For at least some embodiments, the template editor is further configured to receive one or more customer events, and customize the customer specific template, and the customized email based on data obtained from the customer events.

For an embodiment, a customer event includes an action the recipient has taken to engage with a brand/organization of the user. For at least some embodiments, actions the recipient has taken includes one or more of product viewed by the recipient (product information such as pricing, instock status, etc.), product purchased by the recipient (includes product information such as pricing, in-stock status, etc.), onsite action of the recipient (recipient has visited the user's website), emails received by the recipient (recipient has received a previous email from the user; data includes date/time email was sent and received, the specific email that was received, whether the recipient engaged with the email, etc.), and/or engagement by the recipient with an email (email opened, or link within the email clicked).

For an embodiment, the customer event includes a full event (imagine a piece of data that occurs at a certain point in time, for example, when someone (recipient or customer) looks at a product or purchases something) details in the customized email of the customized template.

For at least some embodiments, a customer event includes one or more of the customer active on a website, a bounced email, a cancelled order, a clicked email, a clicked SMS, a consented to receive SMS, a created work order, a dropped email, a failed to deliver SMS, a fulfilled order, a marked email as spam, an opened email, an ordered product, a placed order, a received email, a received SMS, a refunded order, a sent SMS, a started checkout, a subscribed to back in stock, a subscriber list, the customer unsubscribed, the customer unsubscribed from SMS, an updated email preference, and/or a viewed product.

For an embodiment, a customer event is determined through customer tracking. For an embodiment, the customer tracking includes injecting a tracking pixel on an email that is sent to a customer, and detecting by the tracking pixel when the email is opened.

For an embodiment, the customer tracking includes the system operating to append additional parameters onto a URL in an email sent to the customer, and operating to identify and “cookie” the customer when the customer clicks on a link within the email, thereby allowing tracking of the customer selecting the link.

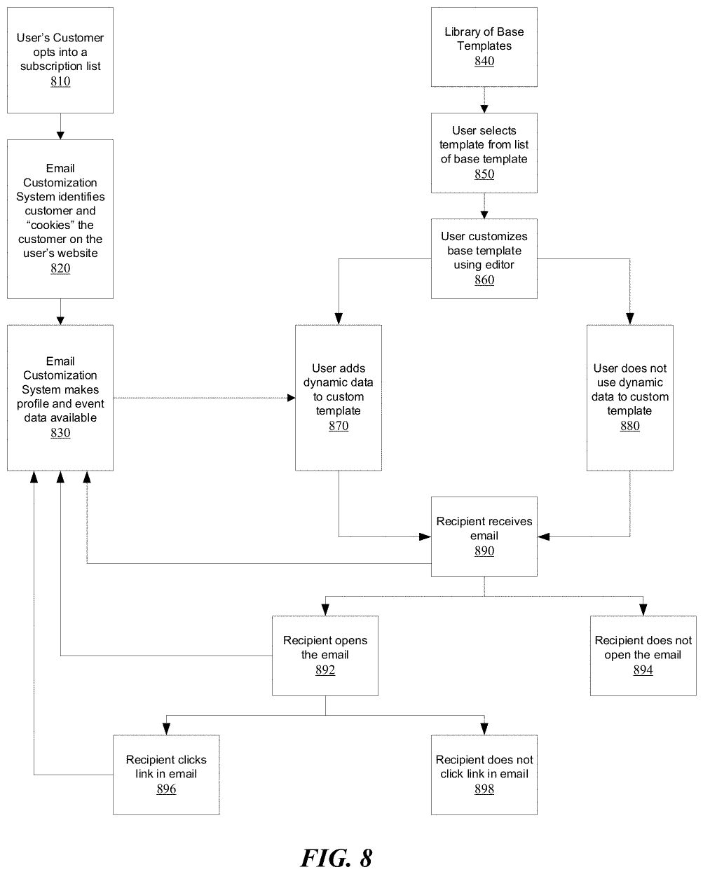

FIG. 8 is a flow chart that includes steps of a method of template serialization for pre-rendering and versioning, according to another embodiment. A first step 810 includes the user's customer opting into a subscription list, thereby allowing for customization of emails for the customer that include the dynamic data. A second step 820 includes the email customization system identifying the customer, and “cookies” the customer and the user's website. A third step 830 includes the email customization system making profile and event data available.

HTTP cookies (also called web cookies, Internet cookies, browser cookies, or simply cookies) are small blocks of data created by a web server while a user is browsing a website and placed on the user's computer or other device by the user's web browser. Cookies are placed on the device used to access a website, and more than one cookie may be placed on a user's device during a session.

In parallel, a fourth step 840 includes establishing a database that includes a library of base templates. A fifth step 850 includes the user selecting templates from the library of templates for generating the customized template. A sixth step 860 includes the user customizing selected base templates to create the customized template using the template editor canvas.

A seventh step 870 further includes the user selecting to add dynamic data to the customized template. If dynamic data is to be used or added to the customize template, then steps 890, 892, 896 all include recipient actions that are identified and collected for generating the dynamic data. The step 890 includes the recipient receiving the email generated by the customized template. For an embodiment, the action of the recipient receiving the email is fed back to step 830 as dynamic data that can be utilized in the generation of the customized emails. The step 892 includes the recipient opening the received email. For an embodiment, the action of the recipient opening the email is fed back to step 830 as dynamic data that can be utilized in the generation of the customized emails. The step 896 includes the recipient clicking or selecting a link included within the email. For an embodiment, the action of the recipient clicking or selecting the link included within the email is fed back to step 830 as dynamic data that can be utilized in the generation of the customized emails.

Step 880 includes the user not utilizing the dynamic data for the customized template. Steps 894, 898 include the recipient not opening the email or selecting the link included within the email.

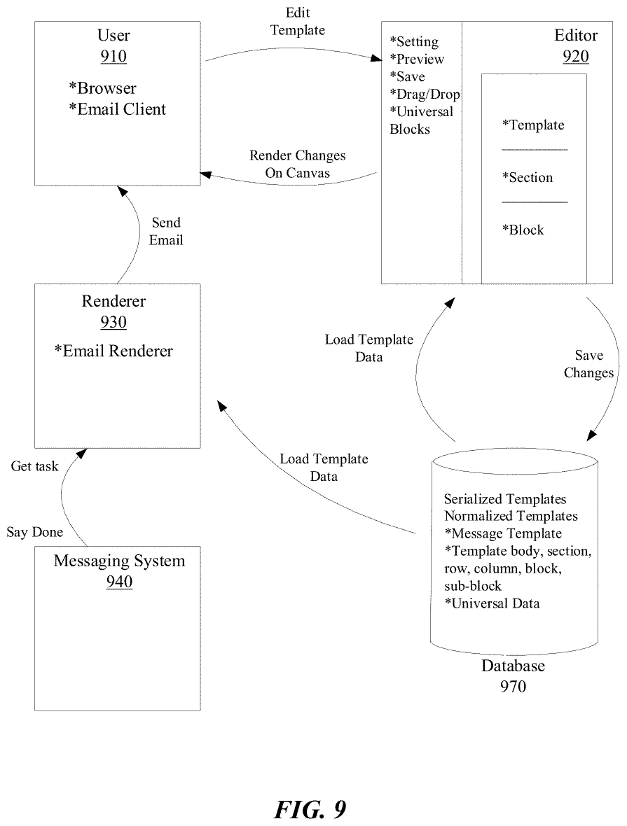

FIG. 9 is a system that operates to perform email customization, according to an embodiment. For an embodiment, FIG. 9 represents the beginning steps of a user client machine 910 working with a customized template within an email template editor 920 where the email template editor loads the selected customized template from the database 970 and enables the user to make and save changes to the selected customized template which are saved back to the database 970. The database 970 serves to power an email renderer 930 where the email renderer 930 is triggered by a messaging system 940 to generate HTML, output which then is sent back to the user client machine 910 into an email inbox. When the email renderer 930 is complete it notifies the messaging system 940 that the email has been rendered.

Although specific embodiments have been described and illustrated, the embodiments are not to be limited to the specific forms or arrangements of parts so described and illustrated. The embodiments are limited only by the appended claims.

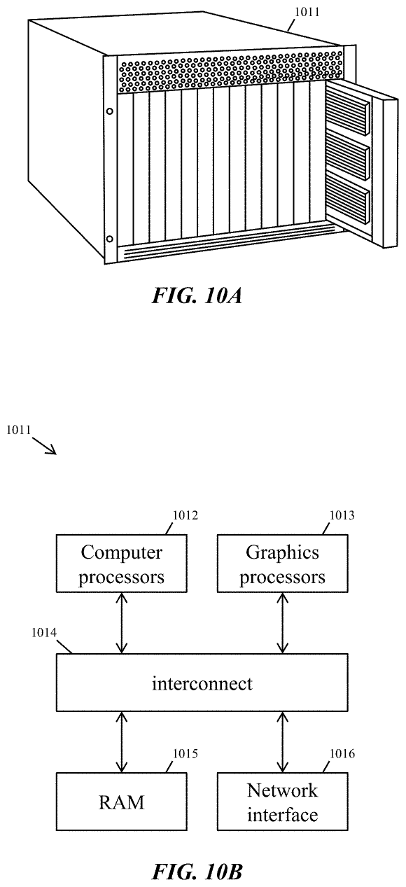

FIG. 10A shows a server system of rack-mounted blades for implementing the present subject matter. Various examples are implemented with cloud servers, such as ones implemented by data centers with rack-mounted server blades. FIG. 10A shows a rack-mounted server blade multi-processor server system 1011. Server system 1011 comprises a multiplicity of network-connected computer processors that run software in parallel.

FIG. 10B shows a diagram of a server system 1011. It comprises a multicore cluster of computer processors (CPU) 1012 and a multicore cluster of the graphics processors (GPU) 1013. The processors connect through a board-level interconnect 1014 to random-access memory (RAM) devices 1015 for program code and data storage. Server system 1011 also comprises a network interface 1016 to allow the processors to access the Internet, non-volatile storage, and input/output interfaces. By executing instructions stored in RAM devices 1015, the CPUs 1012 and GPUs 1013 perform steps of methods described herein.

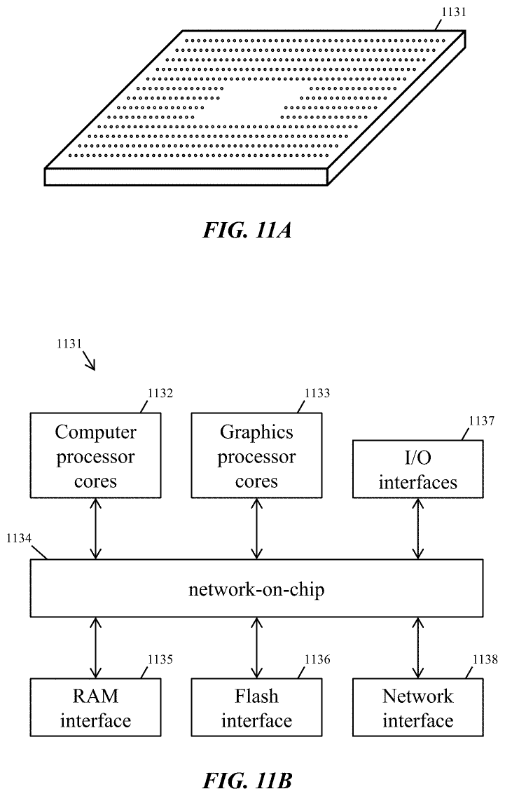

FIG. 11A shows the bottom side of a packaged system-on-chip device 1131 with a ball grid array for surface-mount soldering to a printed circuit board. Various package shapes and sizes are possible for various chip implementations. System-on-chip (SoC) devices control many embedded systems, IoT device, mobile, portable, and wireless implementations.

FIG. 11B shows a block diagram of the system-on-chip 1131. It comprises a multicore cluster of computer processor (CPU) cores 1032 and a multicore cluster of graphics processor (GPU) cores 1033. The processors connect through a network-on-chip 1134 to an off-chip dynamic random access memory (DRAM) interface 1135 for volatile program and data storage and a Flash interface 1136 for non-volatile storage of computer program code in a Flash RAM non-transitory computer readable medium. SoC 1131 also has a display interface for displaying a graphical user interface (GUI) and an I/O interface module 1137 for connecting to various I/O interface devices, as needed for different peripheral devices. The I/O interface enables sensors such as touch screen sensors, geolocation receivers, microphones, speakers, Bluetooth peripherals, and USB devices, such as keyboards and mice, among others. SoC 1031 also comprises a network interface 1138 to allow the processors to access the Internet through wired or wireless connections such as WiFi, 3G, 4G long-term evolution (LTE), 5G, and other wireless interface standard radios as well as Ethernet connection hardware. By executing instructions stored in RAM devices through interface 1135 or Flash devices through interface 1136, the CPU cores 1132 and GPU cores 1133 perform functionality as described herein.

Examples shown and described use certain spoken languages. Various embodiments work, similarly, for other languages or combinations of languages. Examples shown and described use certain domains of knowledge and capabilities. Various systems work similarly for other domains or combinations of domains.

Some systems are screenless, such as an earpiece, which has no display screen. Some systems are stationary, such as a vending machine. Some systems are mobile, such as an automobile. Some systems are portable, such as a mobile phone. Some systems are for implanting in a human body. Some systems comprise manual interfaces such as keyboards or touchscreens.

Some systems function by running software on general-purpose programmable processors (CPUs) such as ones with ARM or x86 architectures. Some power-sensitive systems and some systems that require especially high performance, such as ones for neural network algorithms, use hardware optimizations. Some systems use dedicated hardware blocks burned into field-programmable gate arrays (FPGAs). Some systems use arrays of graphics processing units (GPUs). Some systems use application-specific-integrated circuits (ASICs) with customized logic to give higher performance.

Some physical machines described and claimed herein are programmable in many variables, combinations of which provide essentially an infinite variety of operating behaviors. Some systems herein are configured by software tools that offer many parameters, combinations of which support essentially an infinite variety of machine embodiments.

Several aspects of implementations and their applications are described. However, various implementations of the present subject matter provide numerous features including, complementing, supplementing, and/or replacing the features described above. In addition, the foregoing description, for purposes of explanation, used specific nomenclature to provide a thorough understanding of the embodiments of the invention. However, it will be apparent to one skilled in the art that the specific details are not required in order to practice the embodiments of the invention.

It is to be understood that even though numerous characteristics and advantages of various embodiments of the present invention have been set forth in the foregoing description, together with details of the structure and function of various embodiments of the invention, this disclosure is illustrative only. In some cases, certain subassemblies are only described in detail with one such embodiment. Nevertheless, it is recognized and intended that such subassemblies may be used in other embodiments of the invention. Practitioners skilled in the art will recognize many modifications and variations. Changes may be made in detail, especially matters of structure and management of parts within the principles of the embodiments of the present invention to the full extent indicated by the broad general meaning of the terms in which the appended claims are expressed.

Having disclosed exemplary embodiments and the best mode, modifications and variations may be made to the disclosed embodiments while remaining within the scope of the embodiments of the invention as defined by the following claims.

What is claimed is:

1. A computer-implemented method of iterating a section, the method comprising:
receiving, at an email customization server, a template comprising a section, wherein the section comprises one or more components in a relational database;
assigning a plurality of dynamic data entries to be associated with a dynamic component of the one or more components;
retrieving the plurality of dynamic data entries from one or more custom databases for populating the dynamic component; and
generating iterated sections based on the plurality of dynamic data entries within the template, wherein each dynamic data entry corresponds to a respective iterated section, and wherein each dynamic data entry is configured to populate one dynamic component in one respective iterated section.

2. The computer-implemented method of claim 1, further comprising:
receiving a request to repeat the section within the template based on the plurality of dynamic data entries.

3. The computer-implemented method of claim 1, wherein at least one of the one or more components remain identical in the iterated sections.

4. The computer-implemented method of claim 4, wherein the at least one of the one or more components is configured to render identical features of the iterated sections.

5. The computer-implemented method of claim 1, wherein plurality of dynamic data entries comprises an array that stores multiple pieces of data that are structured in a same way.

6. The computer-implemented method of claim 1, wherein the one or more custom databases comprise at least one of an event database, a customer profile database and a product database.

7. The computer-implemented method of claim 1, wherein the one or more components are hierarchical components.

8. The computer-implemented method of claim 1, wherein the number of the iterated sections corresponds to the quantity of the dynamic data entries.

9. A computer-implemented method, the method comprising:
receiving, at an email customization server, a template comprising grouped components, wherein the grouped components comprise one or more components in a relational database,
assigning a plurality of dynamic data entries to be associated with a dynamic component of the one or more components;
retrieving the plurality of dynamic data entries from one or more custom databases for populating the dynamic component; and
generating iterated grouped components based on the plurality of dynamic data entries within the template, wherein each dynamic data entry corresponds to a respective iterated grouped components, and wherein each dynamic data entry is configured to populate one dynamic component in one respective grouped components.

10. The computer-implemented method of claim 9, further comprising:
receiving a request to repeat the grouped components within the template based on the plurality of dynamic data entries.

11. The computer-implemented method of claim 9, wherein at least one of the one or more components remain identical in the iterated grouped components.

12. The computer-implemented method of claim 11, wherein the at least one of the one or more components is configured to render identical features of the iterated grouped components.

13. The computer-implemented method of claim 9, wherein plurality of dynamic data entries comprises an array that stores multiple pieces of data that are structured in a same way.

14. The computer-implemented method of claim 9, wherein the one or more custom databases comprise at least one of an event database, a customer profile database and a product database.

15. The computer-implemented method of claim 9, wherein the one or more components are hierarchical components.

16. The computer-implemented method of claim 9, wherein the number of the iterated grouped components corresponds to the quantity of the dynamic data entries.

17. A computer-implemented method of iterating a section, the method comprises:
receiving, at a client device, a template comprising a section, wherein the section comprises one or more components in a relational database;
assigning a plurality of dynamic data entries to be associated with a dynamic component of the one or more components;
retrieving the plurality of dynamic data entries from one or more custom databases for populating the dynamic component; and
generating iterated sections based on the plurality of dynamic data entries within the template, wherein each dynamic data entry corresponds to a respective iterated section, and wherein each dynamic data entry is configured to populate one dynamic component in one respective iterated section.

18. The computer-implemented method of claim 17, further comprising:
receiving a request to repeat the section within the template based on the plurality of dynamic data entries.

19. The computer-implemented method of claim 17, wherein the one or more custom databases comprise at least one of an event database, a customer profile database and a product database.

20. The computer-implemented method of claim 17, wherein the number of the iterated sections corresponds to the quantity of the dynamic data entries.
